(19) United States
(12) Patent Application Publication
(10) Pub. No.: US 2006/0155594 A1
(43) Pub. Date: Jul. 13, 2006

(54) Adaptive step-by-step process with guided conversation logs for improving the quality of transaction data

(76) Inventors: Jess Almeida, Pleasanton, CA (US); Kamlesh Amin, San Jose, CA (US); Severo D'Souza, San Jose, CA (US); Cyril Mecwan, Saratoga, CA (US); Koustubh Naik, Pune (IN)

Correspondence Address: Tue Nguyen, 496 Olive Ave., Fremont, CA, 94539, US

(21) Appl. No.: 11/328,938

(22) Filed: Jan. 10, 2006

Related U.S. Application Data
(60) Provisional application No. 60/643,452, filed on Jan. 13, 2005.

(51) Int. Cl. G06F 9/44; G06F 17/50

(52) U.S. Cl. 705/7

(57) ABSTRACT

The present invention discloses a method and system that can produce high quality documentation for real estate transactions by the preparation of a set of real estate related templates with context help and guided questionaires. The real estate transaction process is first organized into various steps, with each step having context help and guided questionaires. Various real estate documents are then attached to each step of the real estate transaction process, with the documents being corresponded to a set of pre-prepared templates with template context help and template guided questionaires. The process through the steps is the served as a guide to guide a user through the real estate transaction process, ensuring completely and accurately preparing the documentations and the real estate transaction.

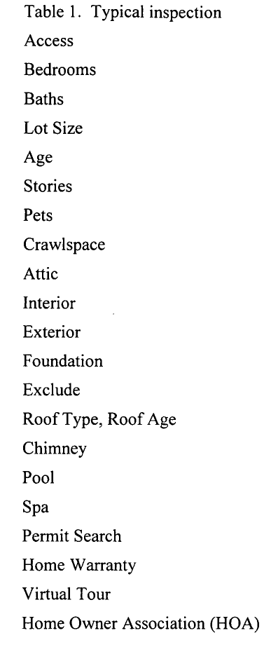

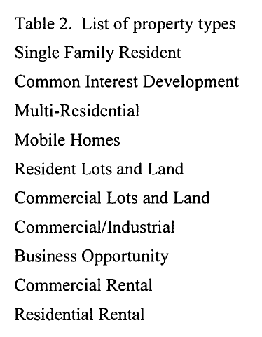

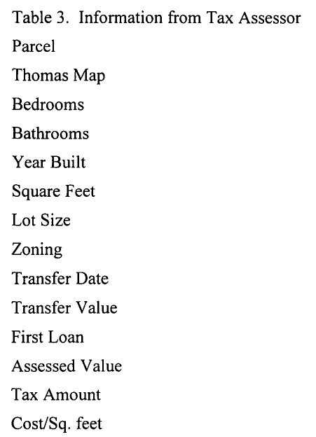

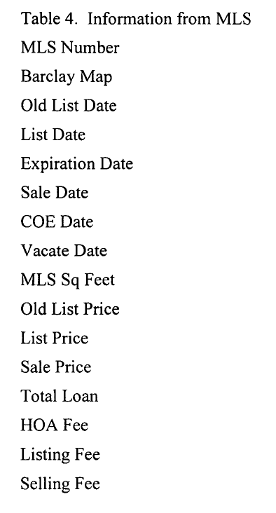

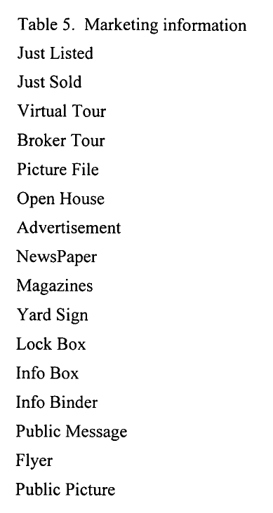

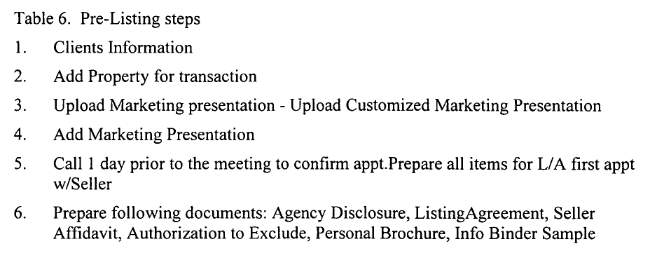

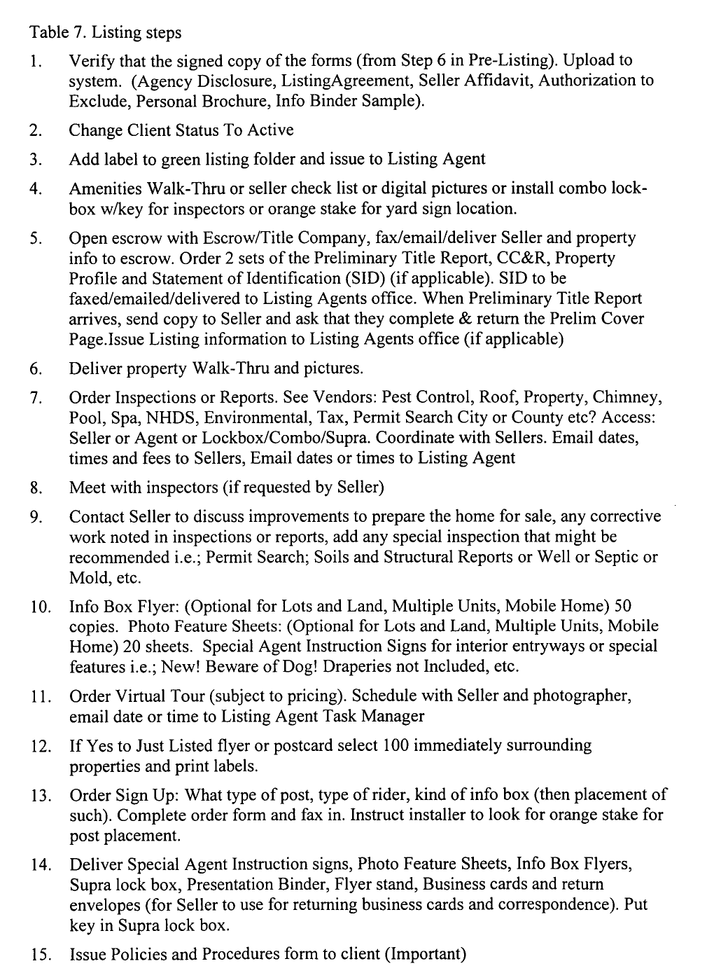

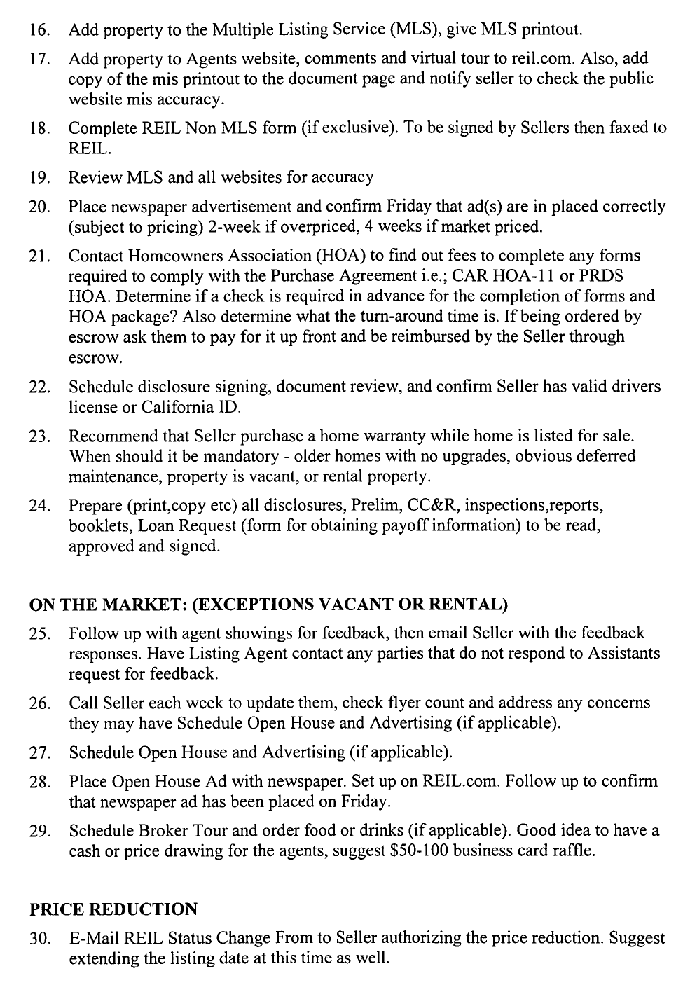

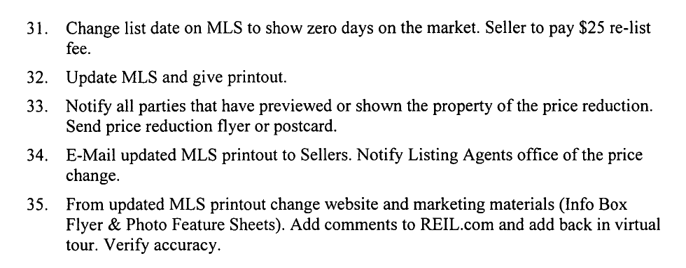

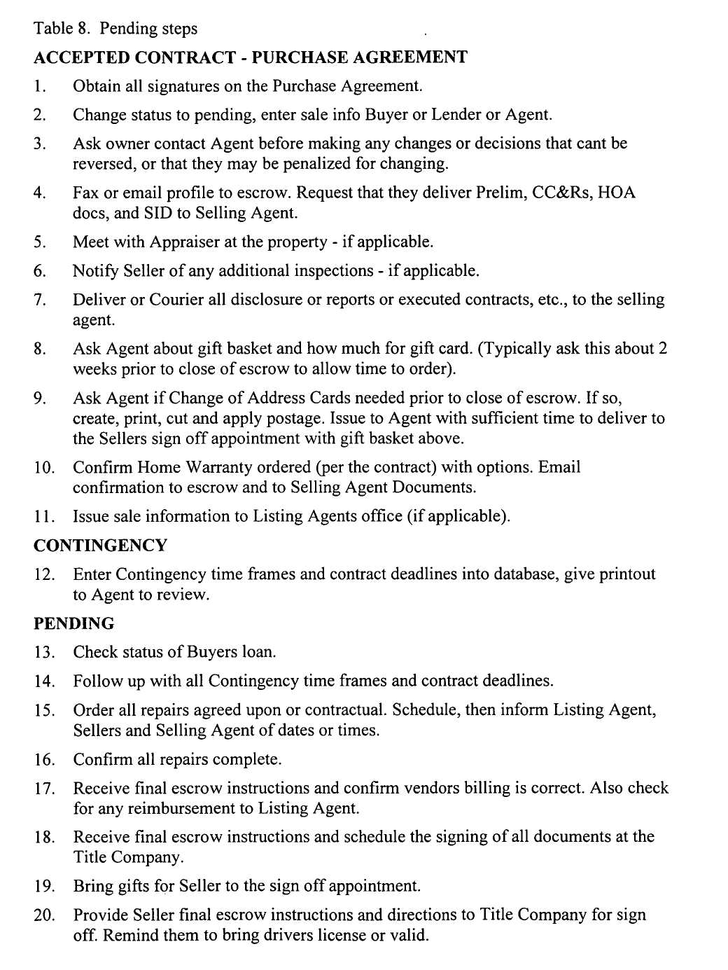

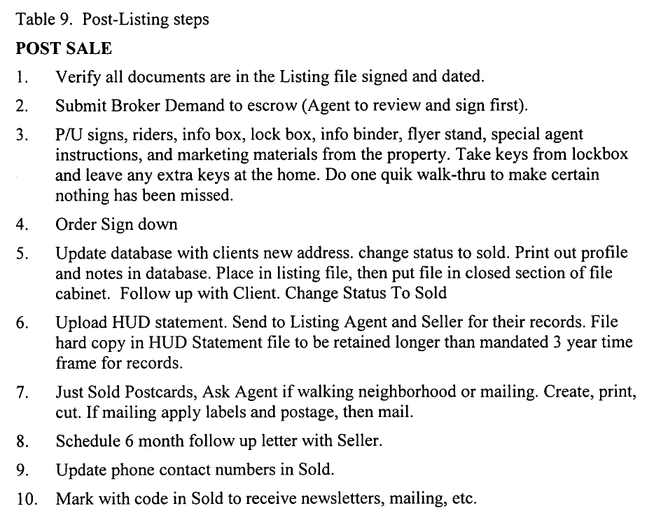

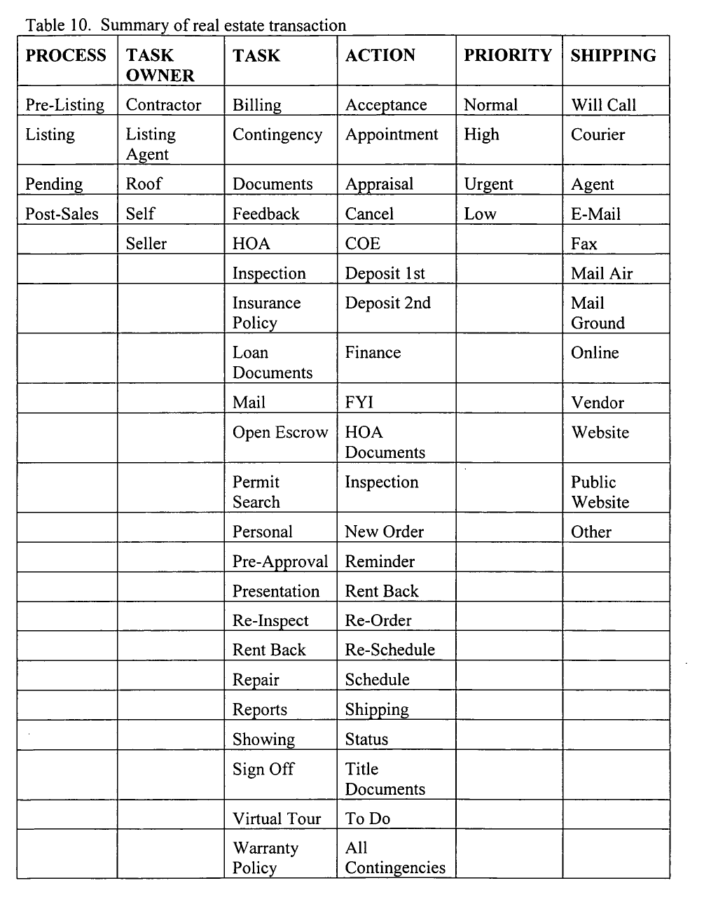

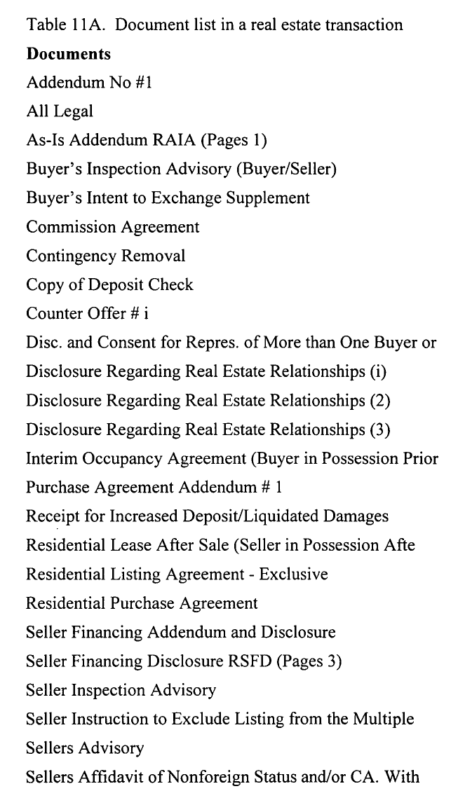

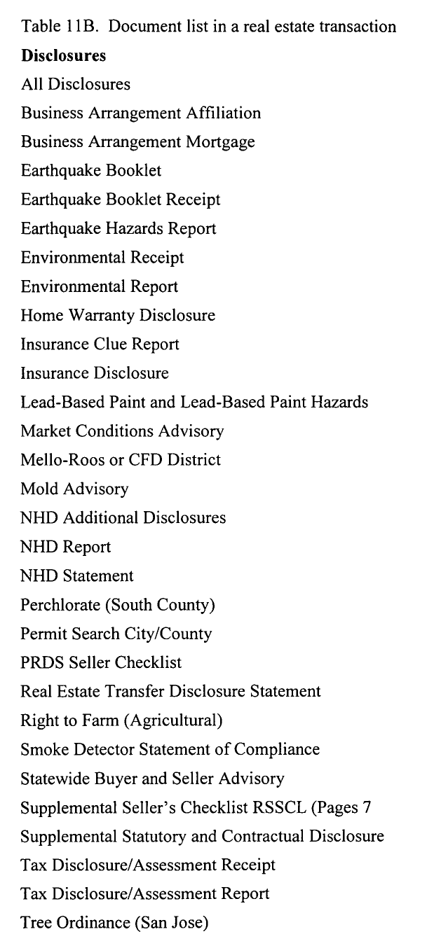

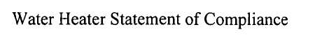

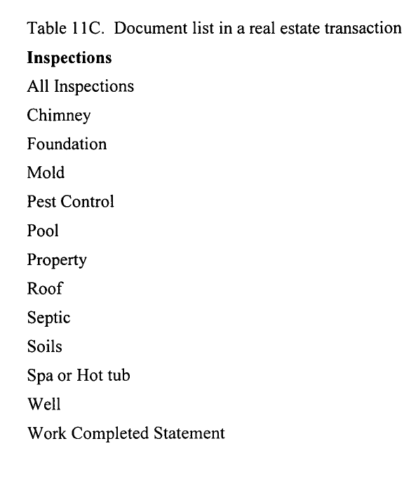

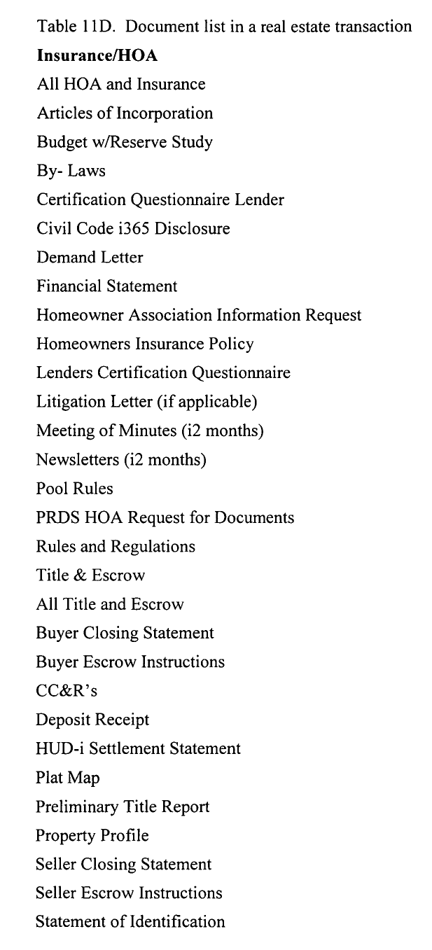

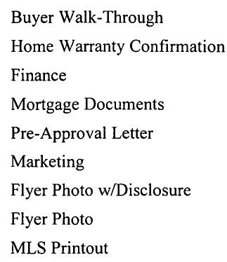

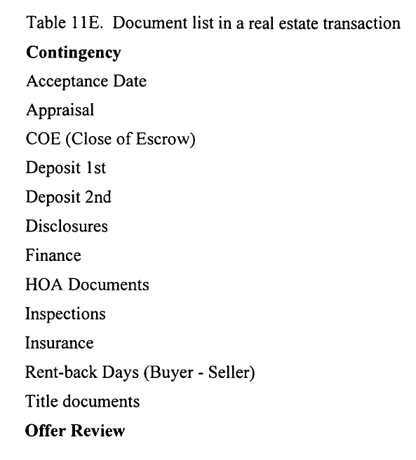

This application claims priority from U.S. provisional applications Ser. No. 60/643,452 filed Jan. 13, 2005, entitled “Adaptive Step-by-Step Process with Guided Conversation Logs for Improving the Quality of Transaction Data” which is incorporated herein by reference.

### FIELD OF THE INVENTION

This application is related to a real estate transaction, and particularly to a simplified and effective method and system to perform real estate services.

### BACKGROUND OF THE INVENTION

Every real estate transaction involves the creation and exchanges of multiple documents between multiple parties, including buyer, seller, their respective agents, brokers, and agencies and various service providers such as financial institutions (e.g., mortgage lenders and underwriters), escrow companies, title companies, insurance companies, construction companies, advertising companies, architects, property inspectors, appraisers, attorneys, property managers, aerial photographers, property photographers, governmental agencies (e.g., county clerk, deed recording).

Thus the aggregation and control of document repository in a real estate transaction are critical due, at least in part, to the number of participants in a transaction and the numerous documents involved, ranging from information disclosure to many needed work completions, and to the constant exchanged, revised and updated actions between multiple parties. There is a need for accurate and complete documentation since the real estate transaction is probably the most expensive purchase of a buyer and it is governed by much rules and regulations.

### SUMMARY OF THE INVENTION

The present invention discloses a method and system that can produce high quality documentation for real estate transactions by the preparation of a set of real estate related templates with context help and guided questionaires. The real estate transaction process is first organized into various steps, with each step having context help and guided questionaires. Various real estate documents are then attached to each step of the real estate transaction process, with the documents being corresponded to a set of pre-prepared templates with template context help and template guided questionaires. The process through the steps is the served as a guide to guide a user through the real estate transaction process, ensuring completely and accurately preparing the documentations and the real estate transaction. Each step can comprise an automatic creation of transaction logs and notes, plus capturing conversation logs and email. The context help can comprise examples and explanations, and the template guided questionaire can comprise guided prompts, plus guiding the user with questions to ask, with situations to look for, and with documentation to prepare. The steps can be re-arranged to accommodate individual user. The real estate transaction process can comprise a step of arranging scheduled works to be performed to achieve the document to be submitted. The property can be classified, for example residential property or commercial property, before the steps are organized. The process also can prepare a set of predetermined message templates to encourage the user to document the transaction, and can include an alert step to alerting of missing documents in a step, where the alerting step notifies the user of the missing documents.

### BRIEF DESCRIPTION OF THE DRAWINGS

Table 1. Typical inspection and billing.

Table 2. List of property types.

Table 3. Information from Tax Assessor.

Table 4. Information from MLS.

Table 5. Marketing information.

Table 6. Pre-Listing steps.

Table 7. Listing steps.

Table 8. Pending steps

Table 9. Post-Listing steps

Table 10. Summary of real estate transaction

Table 11A. Document list in a real estate transaction—Documents

Table 11B. Document list in a real estate transaction—Disclosures

Table 11C. Document list in a real estate transaction—Inspections

Table 11D. Document list in a real estate transaction—Insurance

Table 11E. Document list in a real estate transaction—Contingency and Offer review

### DETAILED DESCRIPTION OF THE INVENTION

Table 1 lists a typical overview inspection area for a real estate transaction according to the present invention. This list can serve as a template for checklist, to ensure the completeness of the inspection.

Table 2 lists the property types in a typical real estate transaction. The present invention allows for the branching of decisions based on property type. The input of the property type can be manually entered, or can be automatically received from Tax Assessor record, or from MLS record.

Table 3 and 4 list the information that a Tax Assessor or a MLS (Multiple Listing Service) can provide. This information can be used for decision branching in the present invention.

Table 5 lists the information needed for marketing a real estate property.

Table 6 lists the steps according to the present invention prior to the listing of a property. Table 7 list the steps according to the present invention for the listing of a property, following the pre-listing steps. The listing steps further includes the steps for putting the property on the market, and the optional steps of reduction in price. Table 8 lists the steps for a pending action, after receiving an offer. Pending steps includes the steps of review the offer, steps for contingency action, and the pending actions. Table 9 lists the steps for the Post-Listing, after selling the property.

Table 10 lists a summary of the real estate transaction, including the processes, the task owners, the tasks, the actions, the priority and the shipping actions.

Tables 11A-E list the documents in a real estate transaction, in which Table 11A lists the documents, Table 11B lists the disclosures, Table 11C lists the inspection documents, Table 11D lists the Insurance and Home Owner Association (HOA) documents, and Table 11E lists the contingency documents and offer review document.

The present invention discloses a method and system that can produce high quality documentation for real estate transactions by the preparation of a set of real estate related templates with context help and guided questionaires. This innovative system provides the methodology and tools to create, guide and catalog documents, transaction logs and notes related to a particular real estate transaction. The system introduces discipline and mitigates the brokers' risk by the use of a step-by-step process, by providing templates for needed documentation, and by providing guided questionaires for necessary situations. The system includes the documentation related to real estate transactions, and further elucidates the user with examples, explanations, and guided prompts to ensure accurately and completely filling the documentation. The system guides the user with questions to ask, with situations to look for, and with documentation to prepare. The system further allows review by recording and cataloging all documentation, including including all documents and agents' conversation logs. The system further allows the tuning of the step-by-step process itself to accommodate individual broker methodology. Scheduling feature is also included for proper timing and coordination of the transaction.

The present invention specifically has been applied to online system for the purpose of transacting a purchase or sale of a real estate property. The process allows the modification and tailoring to different classes of real estate transaction or by brokers' or agents' discretion. For example the processes required for single family residence, home owners association, lots and land, mobile home and business opportunities have different steps. The system automatically adapts and redefines the steps depending on the class the property. The system can look at the tax accessors' database (zoning designation) to make the decision on the step-by-step process to execute. The system can also prompt the user for the decision.

The customer (agent or broker) has the ability to override or tailor the process to their taste using the recommendation generated by the system. The modification, for example, Flip the check list and start at different step, may be “permanent” in nature, where the agent will always use the same procedure or may be “temporary” and applied only to this transaction.

The process is highly collaborative in nature. For example, various parties, namely listing agent, selling, buyer, seller, and other parties, all have access to escrow information on the current status of the escrow. Individual parties are allowed to update the process as it progresses. Automated checklists are divided between all parties in the transaction. The role based responsibilities are enforced by limiting rights for individual parties. Real time update of status is available.

The step by step process organizes the documents required to be submitted and are attached to each step. The documents within the step by step process may be organized the order of priority or importance dictated by the step-by-step process or the document category they belong to. The document during its life cycle may go through several updates (i.e. signatures from various parties). Online status of any document may be queried at any time. The system maintains a transaction log of the documents as they are requested and updated.

The system further provides tools and methods to capture conversation log and email trail. It provides message templates that encourage the agent to generously document the transaction. Electronic communication is facilitated with the message-helper that provides context sensitive messages that may be quickly inserted in the communication. The context environment is created because of systems ability to know what exact step is being transacted at any point of time. Appropriate “canned messages” are available. They may be saved as conversation logs and/or transmitted to the recipients to convey unambiguous messages.

Systems knowledge of the exact step of a transaction provides for risk management capabilities for each step. Missing documents or transaction data in earlier steps gets flagged resulting in automatic alert generation. Alert system then automatically notifies the involved parties of the status of a document, and the status it should be, and alert the party that the document is “behind” for a given step in every step of the process.

The present invention transaction method includes context based guidance to help reduce the errors and omissions. The system enforces an improvement in overall quality of transaction data being captured. Online system maintains and provides status of steps and alerts, anytime and anywhere.

In a preferred embodiment, the present invention discloses an adaptive step-by-step method with guided conversation logs for improving the quality of real estate transactions. The method comprises a set of templates in a real estate transaction with guided questionaires. The method further comprises a predetermined series of steps related to a real estate transaction wherein each step comprises a plurality of choices with selected default choices and a selection wherein an user can choose to skip this step, to jump to a chosen step, to override the default choices, to modify the default choices temporarily, to modify the default choices permanently, to update the documents, to prompt for the a documents to be submitted, to have guided choices to ensure that an user not missing a step or a detail, to have guided conversation tool to ensure that an user not missing a question to ask, to have conversation logs and email trails, to have message templates to encourage agent to document the transaction, to have electronic communications by message helper for providing context sentitive message, to automatic alert system for missing transaction data or document and to automatic alert system for behind for a given step.

The present invention is directed to a system that satisfies the need for a real estate transaction management system which provides an adaptive step-by-step process with guided directions. In an preferred embodiment, the system comprises a server, executing software stored in a hard drive and thereby provides a plurality of document templates within the real estate transaction management system. The document templates can be accessed using the remote computers connected to the server via the Internet. The document templates include the collections of documents and information designed for a particular user of the real estate transaction management system. The document templates further include context help and guided directions to mitigate the brokers' risk, to ensure that all needed information is provided and not missed.

Real estate transaction settlement papers are mostly in predetermined forms, such as HUD-1 settlement sheet, Note, Deed, Deed of Trust (known also as Mortgage), Right of Rescission for a refinance, and all ancillary documents related to a real estate settlement, such as Addendum Page To HUD-1, Contract/Correction Agreement, Limited Power Of Attorney, Owners Affidavit, Survey Affidavit, Compliance Agreement, Owner/Seller Affidavit, Escrow Agreement, Affidavit For Acknowledgment Of Re-Recording, Attorney Representation Letter, Borrower/Seller/Settlement Agent Funding Policy Affidavit, Borrower Certificate/Affidavit, Buydown Agreement, Compliance Agreement, Disclosure Statement, Escrow Waiver Agreement, FHA Firm Commitment, Final Signed 1003 Application, First Lien Title Clearance Letter, First Payment Letter, Flood Hazard Notice, GNMA Refinance Certification, HUD-1 Borrower/Seller/Agent Certification, Initial HUD-1 Escrow Statement, IRS Form 4506, IRS Form 8821, IRS Form W-9 For All Borrowers, Itemization Of Amount Financed, Deed Of Trust Rider(S), Name Affidavits For All Borrowers, Notice Of Assignment Of Servicing Notice Of Right To Cancel Notice To Homeowner, Notice To Mortgagor Relating To Prepayment, Tax Information Sheet, Truth-In-Lending Statement, VA 26-1820, VA Collection Policy Notice, Warranty Of Completion, Consolidated Note, Original Note, Mortgagor's Affidavit, Title Insurance, Survey, FHA HD-1 Addendum, PMI Disclosure, Tax Escrow Designation, Tax Information Sheet And Net Funding Sheet, Authorization And Disbursement, Initial Escrow/Impound-Aggregate Disclosure, Repair Escrow Agreement, W-9's, Notice Of Right To Cancel, Final Truth-In-Lending, Certification Of Occupancy, Monthly Payment Acknowledgement, Occupancy Affidavit, 1040 Form/4506 Form, Smoke Alarm Affidavit, Property Insurance Account Disclosure, Notice To Homeowner, Fraud Notice, Borrower Notification, Criminal Code 1010, VA Disbursement Certificate, Verification Of VA Benefit Form 26-8937, Veterans And Lender Statement, Undertaking And Indemnity, Original Security Agreement, Original Recognition Agreement, Original Property Lease/Occupancy Agreement, Stack Shares Or Membership Certificate Evidencing Ownership, Original Executed Copy Of UCC-1 Financing Statement, UCC-1 Filing Authentication Agreement, Original Executed Copy Of UCC-3, Original Stock Power, Original Assignment Of Property Leas, Restricted Occupancy Certificate, Co-Op Board Supplement, Co-Op Loan Collateral Receipt, Letter Agreement, Affidavit Of Purchaser, Affidavit Of Seller, First Lien Registration Certificate, Corp. Maintenance/Assessment Letter, Good Faith Estimate, Rate Lock-In, Commitment Letter/Addendum, Advance Disclosure Statement, Broker Letter And Copy Of Check, Escrow Waiver, State Required Disclosures, Funding/Wiring Instructions, Name Affidavit, Specific Power Of Attorney, Assignment Of Security Instrument, Security Instrument, Loan Modification Agreement, Tax Information Sheet Signed By Closing Agent, Tax Authorization Letter, Title Binder/Policy, Final Typed Loan Application, Servicing Transfer Disclosure, Adjustable Rate Mortgage Disclosure, Verification Of Deposit Gift Letter, Affordable Housing Mortgage Credit Certificate Worksheet, Affordable Housing Mortgage Credit Certificate, W-4 IRS Worksheet, Sales Contract, Good Faith Estimate, W-9 For Primary Borrower, Telephone Employment Conformation Form. These documents can all be converted to template with context help and guided questionaires according to the present invention.

The invention uses a database to minimize the risk involved in the preparation of all documentation needed for real estate closings. Information input into the database is used to generate the documentation necessary to complete real estate transfers, including all forms required by relevant financial institutions and government agencies. Context help and guided questionaires are included to ensure completely and accurately preparing the documentation. Further included are scheduling features for coordinating the many tasks of a real estate transaction.

The system can help to ensure that all necessary scheduling details in negotiating and closing a purchase contract for real estate property are not overlooked. For example, state regulations might require certain inspections or that certain types of mortgage applications might require a certain period of time and additional procedures. Consequently, the present invention prompts the user of these scheduling considerations when negotiating a purchase contract. The system also can provide assistance in completing the purchase contract form.

The disclosed templates with guided questionaires conform to the business rules and functionality of the real estate transactions. Preferably, the templates are grouped according to the time line of the transaction. The templates can also grouped according to categories, such as transaction types, party types and service types. The transaction type templates include the forms that are available for a real estate transaction, with the prompting for the core transaction data pertaining to a particular transaction. The party type templates include the forms related to the parties in a real estate transaction, with the prompting for the data pertaining to a particular party. For example, the prompting asks for pets, and for specific instructions regarding pets, to address the case that an owner may have an indoor cat which continually tries to go out of doors. The service type templates include the forms related to the services which can be ordered. There are linkages between the templates with prompting to lead from one template to another.

What is claimed is:

1. An adaptive step by step method with guided conversation logs for improving the quality of a real estate transaction, the method comprising
organizing the real estate transaction into steps;
attaching into each step the real estate documents to be submitted, the documents being corresponded to a set of pre-prepared templates with template context help and template guided questionaires;
attaching into each step a step context help and step guided questionaires;
guiding an user through the steps of the real estate transaction,
wherein the context help and guided quiestionaires ensure completely and accurately preparing the documentations and the real estate transaction.

2. A method as in claim 1 further comprising a step of cataloging the real estate documents to form a binder.

3. A method as in claim 1 further comprising a step of automatically creating a transaction logs and notes during each step.

4. A method as in claim 1 wherein the template context help comprises examples and explanations.

5. A method as in claim 1 wherein the template guided questionaire comprises guided prompts.

6. A method as in claim 1 wherein the template guided questionaire comprises guiding the user with questions to ask, with situations to look for, and with documentation to prepare.

7. A method as in claim 1 further comprising a step of re-arranging the real estate steps to accommodate individual user.

8. A method as in claim 1 further comprising a step of scheduling works to be performed to achieve the document to be submitted.

9. A method as in claim 1 further comprising a step of classifying the property of the real estate transaction before organizing the steps.

10. A method as in claim 1 further comprising a step of looking into the database of the tax assessor to determine the class of the property.

11. A method as in claim 1 wherein the organizing step organizes the real estate transaction into steps according to the order of priority or importance, according to the categories of the transaction, or according to the timeline of the transaction.

12. A method as in claim 1 further comprising a step of capturing conversation logs and email at each step.

13. A method as in claim 1 further comprising a step of preparing pre-determined message templates to encourage the user to document the transaction.

14. A method as in claim 1 wherein the context is defined based on the step of the transaction.

15. A method as in claim 1 further comprising an alert step to alerting of missing documents in a step.

16. A method as in claim 1 wherein the alerting step notifies the user of the missing documents.

17. An adaptive step by step method with guided conversation logs for improving the quality of a real estate transaction, the method comprising
providing property classes before organizing the steps
organizing the real estate transaction into steps, with branches due to different property classes;
attaching into each step the real estate documents to be submitted, the documents being corresponded to a set of pre-prepared templates with template context help and template guided questionaires;
attaching into each step a step context help and step guided questionaires;
guiding an user through the steps of the real estate transaction, while automatically creating a transaction logs and notes, and capturing conversation logs and email during each step,
wherein the context help and guided quiestionaires ensure completely and accurately preparing the documentations and the real estate transaction.

18. A method as in claim 1 wherein the template guided questionaire comprises guiding the user with questions to ask, with situations to look for, and with documentation to prepare.

19. A method as in claim 1 further comprising a step of looking into the database of the tax assessor to determine the class of the property.

20. A method as in claim 1 further comprising a step of preparing pre-determined message templates to encourage the user to document the transaction.
